(19) United States
(12) Patent Application Publication
(10) Pub. No.: US 2007/0029418 A1
(43) Pub. Date: Feb. 8, 2007

(54) Infectious waste treatment

(76) Inventors: Felix F. Jakobi, Long Beach, CA (US); James F. Bennett, La Mirada, CA (US)

Correspondence Address: AVERILL & VARN, 8244 PAINTER AVE., WHITTIER, CA, 90602, US

(21) Appl. No.: 11/190,343

(22) Filed: Jul. 26, 2005

(51) Int. Cl. B02C 19/00

(52) U.S. Cl. 241/21; 241/242

(57) ABSTRACT

A waste treatment system grinds waste material into small pieces and soaks the pieces in a liquid disinfectant. The system includes a hopper, a grinder, a main solution tank, and an auger. Unprocessed waste material is dumped into the hopper. The hopper feeds the unprocessed waste material into the grinder. The grinder includes a rotor and anvil for grinding the unprocessed waste material. The ground material falls into the main solution tank where the ground material is wetted with the liquid disinfectant. The wetted waste is carried from the main solution tank by the auger and spends an additional two to three minutes of wetted time on the auger before entering a de-watering section. The total wetting time allows the waste material to be completely disinfected.

### BACKGROUND OF THE INVENTION

The present invention relates to a device and method for treatment of waste and in particular to the treatment of infectious waste from a hospital.

In the normal course of operation, hospitals generate a variety of waste which is not suitable for normal disposal. While some or most hospital waste may be harmless, it is difficult to distinguish such harmless waste from infectious waste. As a result, all of the waste from a hospital must be treated as if it may be harmful. Also, sensitivity to the handling of hospital waste has been raised as a result of AIDS and other health issues. Recently, the bird flu spread rapidly and initially was not well understood. As world travel has increased, so has the ability of infections, like the bird flu, to spread rapidly, and the need to contain outbreaks is greater than ever before. For all of these reasons, there is a need to deal properly with hospital waste.

Common methods of treating hospital waste include systems having a steam autoclave or an ethylene oxide autoclave. U.S. Pat. No. 6,726,136 for “Waste treatment plant,” describes a system including an autoclave. Other systems include incinerators. Unfortunately, incinerators may be difficult to construct and operate, and may create environmental issues. Autoclaves may also be expensive and difficult to operate. Systems including autoclaves may also require additional steps to complete disinfecting waste.

U.S. Pat. Nos. 5,425,925 and 5,656,248 for “Multi-stage infectious waste treatment system,” both assigned to the assignee of the present application, describe waste treatment systems which grind waste into small particle size, and then soak the waste in a volatile liquid disinfectant. Unfortunately, while the systems described in the '925 and the '248 patents successfully treat most hospital waste, some hospital waste has been found to contain material, such as titanium prosthetic joints, which may cause jamming. The '925 and the '248 patents are herein incorporated by reference.

### BRIEF SUMMARY OF THE INVENTION

The present invention addresses the above and other needs by providing a waste treatment system which grinds waste material into small pieces and soaks the pieces in a liquid disinfectant. The system includes a hopper, a grinder, a main solution tank, and an auger conveyer. Unprocessed waste material is dumped into the hopper. The hopper feeds the unprocessed waste material into the grinder. The grinder includes a rotor and anvil for grinding the unprocessed waste material. The ground material falls into the main solution tank where the ground material is wetted with the liquid disinfectant. The wetted waste is carried from the main solution tank by the auger, and spends an additional two to three minutes of wetted time on the auger conveyer before entering a de-watering section. The total wetting time allows the waste material to be completely disinfected.

In accordance with one aspect of the invention, there is provided an apparatus for infectious waste treatment. The apparatus comprises a lift for lifting a waste container to a hopper, a hopper for receiving waste material from the waste container, a grinder for receiving the waste material directly from the hopper and grinding the waste material, a main solution tank for receiving and wetting the ground waste material, and an auger for carrying the wetted material from the main solution tank. The grinder comprises a rotor positioned below the hopper, an anvil in grinding cooperation with the rotor, and a sizing screen for controlling the size of the ground waste material. A liquid disinfectant is sprayed onto the ground waste material in the main solution tank, and a chopper pump circulates the liquid disinfectant.

In accordance with another aspect of the invention, there is provided a method for treating hospital waste. The method includes pouring waste material into a hopper, providing the waste material to a grinder, grinding the waste material in the grinder, wetting the ground waste material with a liquid disinfectant, and carrying the wetted waste material on an auger for between two and three minutes.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a waste treatment system according to the present invention.

FIG. 2A shows a lift for lifting a waste container to dump waste material carried by the waste container into a hopper of the waste treatment system.

FIG. 2B shows the waste being dumped into the hopper.

FIG. 3A shows a side view of a grinder suitable for use with the waste treatment system.

FIG. 3B shows a top view of the grinder.

FIG. 3C shows an end view of the grinder (note the grinder resides sideways in the waste treatment system.)

FIG. 4 is a cross-sectional view of the grinder taken along line 4-4 of FIG. 3B.

FIG. 5 is a cross-sectional view of the grinder taken along line 5-5 of FIG. 3B.

FIG. 6A is a side view of a main solution tank suitable for use with the waste treatment system.

FIG. 6B is a top view of the main solution tank.

FIG. 7 is a cross-sectional view of the main solution tank taken along line 7-7 of FIG. 6B.

FIG. 8 is a second side view of the main solution tank (opposite side) showing a gas monitoring system, a chopper and recirculation pump, and a liquid disinfectant generator.

FIG. 9 is a method of waste treatment according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

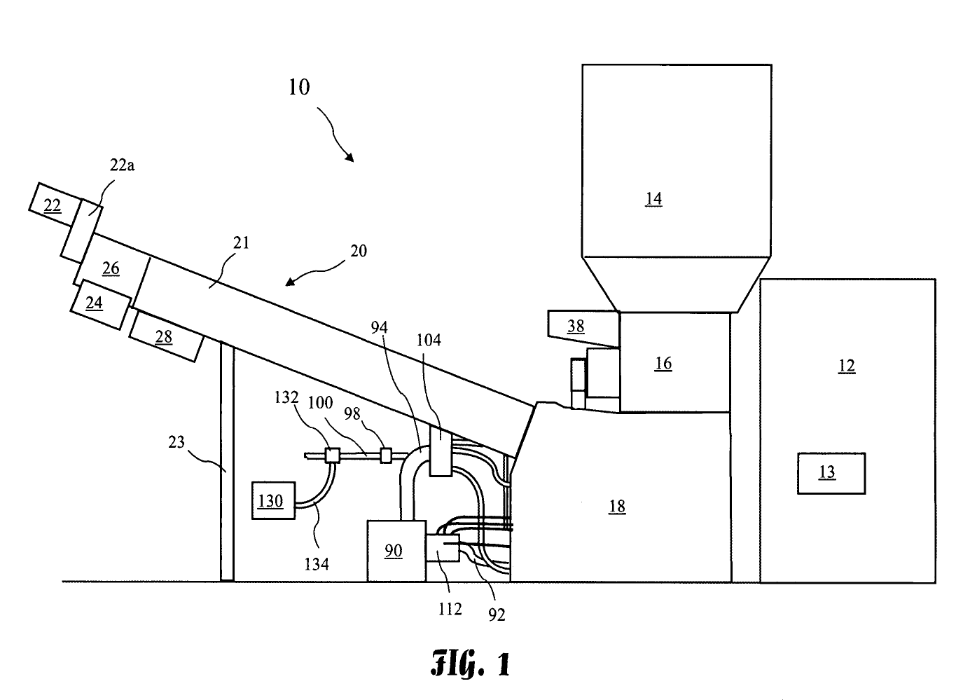

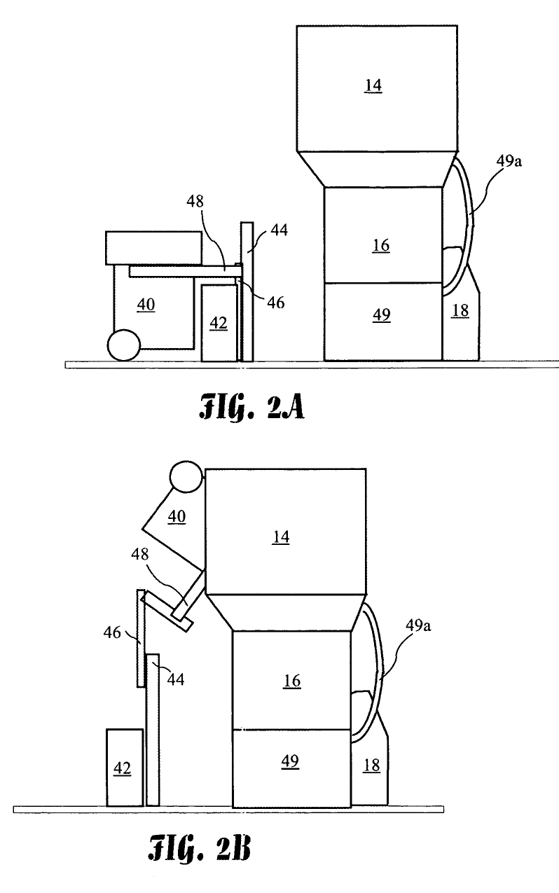

A waste treatment system 10 according to the present invention is shown in FIG. 1. The waste treatment system 10 includes a cage 12, hopper 14, a grinder 16, a main solution tank 18, and an auger 20. A hospital waste container 40 is placed into the cage 12 where a lift unit 42 lifts the container 40 and dumps hospital waste carried in the container 40 into the hopper 14 (see FIGS. 2A and 2B). The hopper 14 resides above the grinder 16 and feeds the waste into the grinder 16. The grinder 16 grinds the waste, and the ground waste drops into the main solution tank 18 where the ground waste is wetted in a disinfectant liquid. The auger 20 lifts the wetted waste from the main solution tank 18 and completes the waste treatment. A radioactive material detector 13 resides in the cage 12. When the radioactive material detector 13 detects radiation in the hospital waste, the waste treatment system 10 is turned off and an alarm is sounded. An example of a suitable radioactive material detector is Micro Bomb Detector made by Al NOTL Systems Inc. In Ontario, Canada.

Continuing with FIG. 1, a pump 90 receives disinfectant liquid from the main solution tank 18 through a pump inlet line 92, and returns the disinfectant liquid through a pump outlet line 94 through a manifold 104. A drain line 100 is connected to the pump outlet line 94 through a drain valve 98. A neutralizer tank 130 is connected to the drain line 100 at a neutralizer injector 130 for neutralizing the drained disinfectant liquid. The pump 90 is preferably a chopper pump, and is more preferably a high flow rate pump, and most preferably an approximately 200 Gallon Per Minute (GPM) pump. An example of a suitable 200 GPM pump is a model number HE3G6SEC-055 chopper pump manufactured by Vaughn Company in Montesano, Wash. In some cases, two separate pumps may be used to recycle the disinfectant liquid and to spray the disinfectant liquid onto the waste material. When two pumps are used, the pumps are preferably approximately 90 Gallon Per Minute (GPM) pumps.

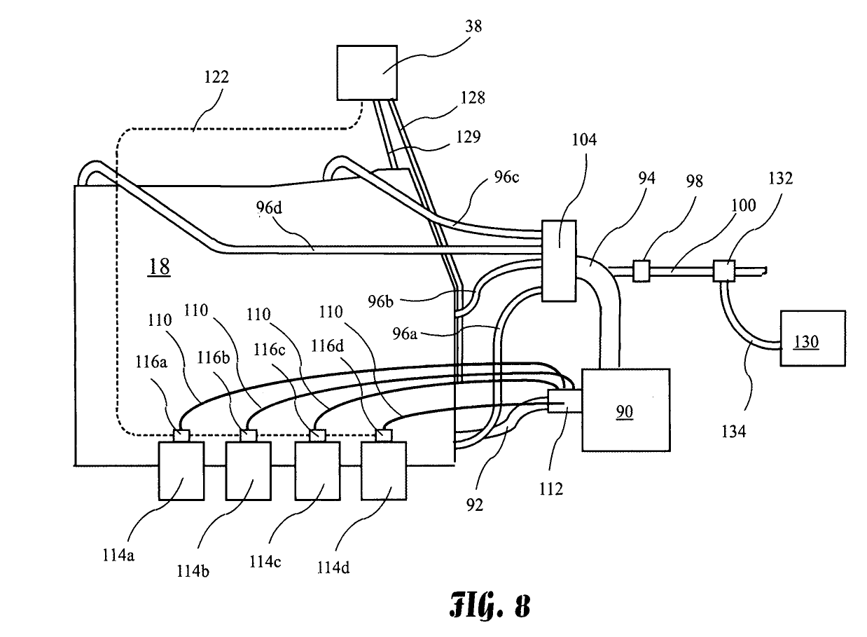

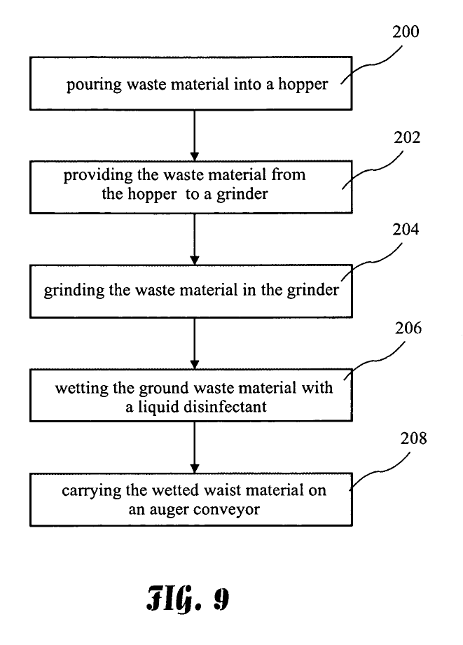

A continuous gas monitoring system 38 monitors the liquid disinfectant level in the main solution tank 18 and composition (i.e., strength) of the liquid disinfectant, and controls the generation of liquid disinfectant (see FIG. 8). For example, chemicals may be introduced into a flow into the pump 90 at a chemical manifold 112 to generate liquid disinfectant. An example of a continuous gas monitoring system 38 is the system described in U.S. Pat. No. 5,269,832 for “Method and Apparatus for Continuously Measuring the Concentration of Chemicals in Solution.” The '832 patent is herein incorporated by reference.

The auger 20 is preferably a shaftless auger residing in an auger housing 21 supported by an auger strut 23 and is powered by an auger motor 22 which is preferably connected to the auger 20 through a gearbox 22a. The auger 20 further includes a fluid trap 28 where the liquid disinfectant used to wet the ground waste is trapped and recirculated back into the main tank. A rotatable section 26 of the auger housing 21 may be rotationally positioned relative to the auger housing 21 at various rotations to adjust the position of a chute 24. If the chute 24 is pointed down, the back pressure on the flow of the ground waste is minimized, and the amount of liquid disinfectant removed by the fluid trap 28 is minimized. As the chute 24 is rotated away from a pointed down position, the back pressure on the flow of the ground waste is increased, and the amount of liquid disinfectant removed by the fluid trap 28 is increased. If the chute 24 is rotated to an upward position, the back pressure on the flow of the ground waste is maximized, and the amount of liquid disinfectant removed by the fluid trap 28 is maximized.

A lift 42 for lifting a waste container 40 to dump waste into the hopper 14 of the waste treatment system 10 is shown in FIG. 2A. Grasping arms 48 are attached to a lift trolley 46 which travels on tracks 44. FIG. 2B shows the waste container 40 grasped and lifted by the grasping arms 48, and the waste being dumped into the hopper 14. A filter system 49 is connected to the hopper 14 by a filter hose 49a. The filter system 49 includes a fan to draw air from the hopper 14, and preferably includes a High Efficiency Particle Arresting (HEPA) filter.

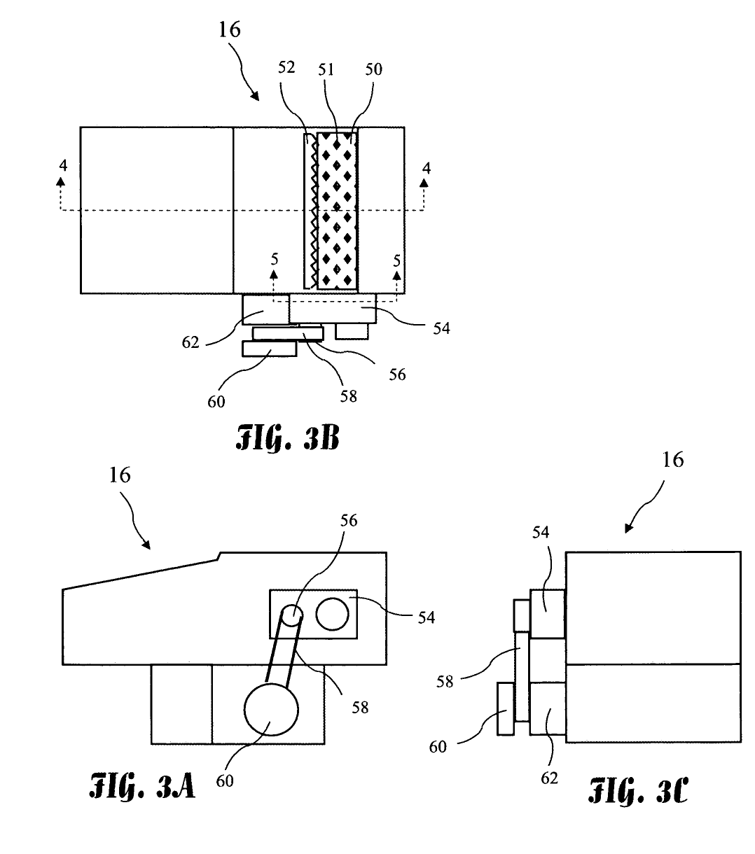

A side view of a grinder 16 suitable for use with the waste treatment system 10 is shown in FIG. 3A, a top view of the grinder 16 is shown in FIG. 3B, and an end view of the grinder (note the grinder resides sideways in the waste treatment system) is shown in FIG. 3C. The grinder 16 includes a rotor 50 having teeth 51. An anvil 52 cooperates with the rotor 50 to grind the waste material. Power is provided to the rotor by a grinder motor 62. A fluid coupling 60 connects the motor 62 to a belt 58. The belt 58 connects the fluid coupling 60 to a hub 56 on a grinder gear box 54, and the gear box 54 contains gears connecting the hub 56 to the rotor 50.

A cross-sectional view of the grinder 16 taken along line 4-4 of FIG. 3B is shown in FIG. 4. The rotor 50, teeth 51, and anvil 52 are fed by a ram 64, which is preferably a hydraulic ram connected to hydraulics 68. The ram 64 moves toward and away from the rotor 50 as shown by arrow 66. The ram 64 is controlled to provide efficient operation of the rotor 50 and anvil 52, for example, if the ram 66 senses high resistance to motion toward the rotor 50, the speed of the ram 66 is reduced, and if the ram 66 senses low resistance to motion toward the rotor 50, the speed of the ram 66 is increased. A sizing screen 79 resides under the rotor 50, thereby limiting the maximum size of ground waste material which may fall into the main solution tank 18. The sizing screen 79 may be selected with a hole size to control the size of the ground material, the holes are preferably between approximately ½ inch diameter and approximately three inch diameter.

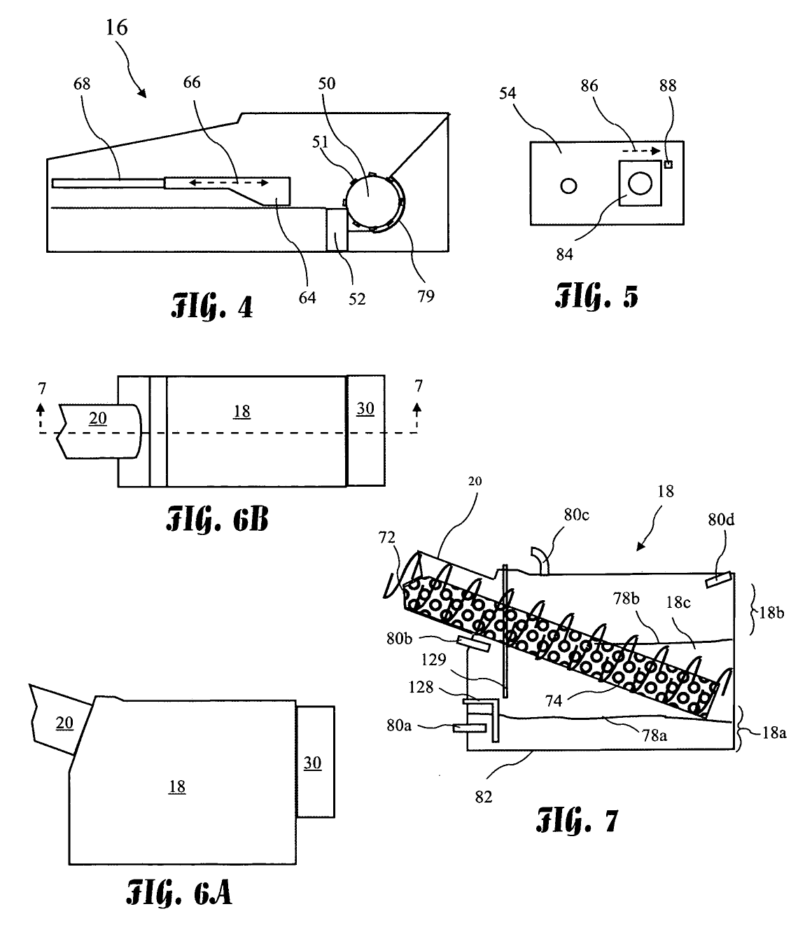

A cross-sectional view of the gearbox 54 taken along line 5-5 of FIG. 3B is shown in FIG. 5. The rotor 50 and gearbox 54 are mounted to the grinder 16 to allow motion 86 of the rotor 50 and gearbox 54 if force is exerted on the rotor 50 by the anvil 52, thus moving the rotor 50 away from the anvil 52. If the motion 86 is sufficient, a switch 88 turns the motor 62 off to avoid damage to the grinder 16.

A side view of the main solution tank 18 suitable for use with the waste treatment system 10 is shown in FIG. 6A, a top view of the main solution tank 18 is shown in FIG. 6B. A cross-sectional view of the main solution tank 18 taken along line 7-7 of FIG. 6B is shown in FIG. 7. An auger screw 72 extends though the main solution tank 18 and is cupped by an auger floor 74 which is preferably an auger screen extending under approximately half of the circumference of the auger screw 72. The liquid disinfectant resides in a lower portion 18a of the main solution tank 18 with a static fluid level 78a. Additionally, while the waste treatment system 10 is in operation, the liquid disinfectant resides at a dynamic level 78b above the auger floor 74 in a wetting portion 18c of the main solution tank 18. The dynamic liquid level 78b is maintained in equilibrium by the cooperation of pumping the liquid disinfectant into an upper portion 18b of the main solution tank 18 and the liquid disinfectant draining through the auger floor 74 into the lower portion 18a of the main solution tank.

Continuing with FIG. 7, a first nozzle 80a provides a flow of the liquid disinfectant into the lower portion 18a of the main solution tank to provide circulation of the liquid disinfectant, a second nozzle 80b provides a flow of the liquid disinfectant into the upper portion 18b of the auger end of the main solution tank 18, a third nozzle 80c provides a flow of the liquid disinfectant into the upper portion 18b of the main solution tank 18 near the auger end of the main solution tank 18 (i.e., where the auger 20 enters the main solution tank 18), and a fourth nozzle 80d is positioned opposite the auger end of the main solution tank 18 and provides a flow of the liquid disinfectant directed towards the auger screw 72.

A bubble tank assembly 128 is partially submerged in the disinfectant liquid below the static fluid level 78a and to preferably within approximately one half inch of the bottom of the main solution tank 18, and is further described in FIG. 8. A gas sample tube 129 resides in the main solution tank 18 and has a lower end above the static fluid level 78a, and preferably between approximately six inches and approximately eight inches above the static fluid level 78a.

A second side view of the main solution tank 18 (an opposite side view from FIG. 1 or 7) showing the continuous gas monitoring system 38, the pump 90, and liquid disinfectant generator elements are shown in FIG. 8. The pump 90 draws the liquid disinfectant from the lower portion 18a of the main solution tank 18 through the inlet line 92 and returns the liquid disinfectant to the nozzles 80a, 80b, 80c, and 80e (see FIG. 7) through nozzles lines 96a, 96b, 96c, and 96e respectively connected to the circulation pump 90 by the outlet line 94 through the manifold 104. The drain valve 98 is also connected to the outlet line 94, and a drain line 100 is connected to the drain valve 98 to allow convenient draining of the main solution tank 18. A neutralizer tank 130 is connected to a neutralizer nozzle 132 in the drain line 100 by a neutralizer line 134. The neutralizer neutralizes the disinfectant liquid, and is preferably sodium sulfite.

The continuous gas monitoring system 38 measures the liquid disinfectant depth and concentration using the bubble tank assembly 128 and the gas sample tube 129 (also see FIG. 7). The continuous gas monitoring system 38 provides control signals over a control cable 122 to valves or pumps 16a, 116b, 116c, and 116d to control a flow of liquid disinfectant precursors from chemical tanks 114a, 114b, 114c, and 114d to a second manifold 112. The liquid disinfectant precursors preferably comprise an approximately 12 percent industrial clorox bleach (i.e., sodium hypochlorite), an approximately 12 percent to approximately 50 percent citric acid solution, an approximately 25 percent sodium chlorite solution as precursors for chlorine dioxide, and an anti-form agent.

The continuous gas monitoring system 38 includes a continuous gas monitoring device which uses a diaphragm pump to provide the gas flow received through the gas sample tube 129 to a sensor. The sensor's electrical output is sent through a sensor circuit board to a digital panel meter which processes the sensor output and produces a digital readout in Parts Per Million (PPM) of the chemical levels in the liquid disinfectant. The continuous gas monitoring system 38 compares the measured gas level to the preset alarm levels and activates alarm indicators when gas levels exceed user set levels. If low gas levels are detected, a signal is sent to the liquid disinfectant generator to generate additional chlorine dioxide. If the liquid disinfectant is low, water is added to the systems. The continuous gas monitoring system 38 further includes data logging for recording data including chemical levels, fluid level, maintaining level, and kill ratio.

The static liquid level 78a (see FIG. 7) of the liquid disinfectant in the main solution tank 18 is measured using the bubble tank assembly 128 (see FIG. 7). The bubble tank assembly 128 comprises a six-inch cylinder sealed at the top with a one half inch tube protruding through the top of the seal and extending one half-inch past the bottom of the cylinder. A second one half-inch tube extends just through the seal into the top of the cylinder. The bubble tank assembly 128 is submerged in the liquid disinfectant in the main solution tank 18 to a depth wherein the longer tube is approximately one half-inch from the bottom of the main solution tank 18. Low-volume air is injected through the longer tube and the resulting pressure inside the cylinder is measured and converted to a measurement of depth of the liquid disinfectant in the main solution tank 18.

In an exemplar embodiment, the continuous gas monitoring system 38 includes an electrical control panel, a pump control box, and an operator console. The electrical control panel comprises a PLC control unit, variable frequency drives for the grinder and auger, motor starters for fan and pump, 120VAC and 24VDC control voltage supplies. The pump control box comprises chemical pumps, chemical concentration, reservoir tank water level and air pressure controls, and a three light stack alarm annunciator. The operator console comprising a six inch touchscreen Human Machine Interface (HMI) operator interface display, Start-Stop and Emergency Stop control operators, waste bin color detectors and weight scale. The hydraulic unit control box comprises hydraulic unit controls and position sensors junction terminal blocks.

All system functions are completely automatic controlled by a Programmable Logic Controller (PLC) unit and the HMI display. All the operator needs to do is load the waste bin in the bin cage and press the start button on the operator console. The system will start functioning in a pre-programmed sequence. The complete process is monitored for time, water level, and chemical concentration by the PLC unit. Should any operating parameters deviate from normal, treatment is automatically halted and the control panel alerts an operator. The operation of the system can be monitored on the HMI display as explained below.

Before powering the system for the first time, the following checking steps are performed. Ensure all power cords are securely fastened (cord plugs preferably have a guide notch to prevent wrong connection of the plug to the receptacle, if a cord is unplugged, ensure that the system power is turned off, and re-plug). Check hydraulic unit oil level is normal. Ensure chemical containers are connected and are at least 30 percent full. Check for water leakages in the system. And lastly, ensure a water supply is present.

The waste treatment system 10 may be started by executing the following steps. Turn power on at the electrical panel (the 120VAC and 24VDC power indicator lights that are on the right side of the panel should light.) Make sure there is no alarm message on the HMI display and the 3-stack light is green. Check that the bin lift is at the extreme down position. If alarm messages are present, bring the lift down manually by using the touch buttons on the HMI display. Load the waste bin in the bin cage and make sure the cage door is firmly closed. Make sure that the E-Stop push button is released. If the green lamp on the operator console is not on, then press the Reset button. The green lamp should then turn on. And lastly, press the start button. The system will now start to run in the following sequence based on the color of the waste bin, Red=Medical waste, Grey=Cafeteria (non medical) waste. The HMI display will indicate the operating mode. If the mode must be set manually, the mode can be set on the HMI display Mode select page. The operation of the system may also be monitored on the HMI display as explained below.

An operating sequence for the waste treatment system 10 comprises the following steps. The lift will lift the waste bin and empty the contents in to the hopper (there is a 5 sec delay at the top emptying position). The shredder, auger and HEPA fan will start running. If in Medical mode, the circulation pumps will start running. The lift will lower the waste bin. The hopper door will close. If in Medical mode, the chlorine dioxide generator will start pumping chemicals into the system based on the chemical concentration set point adjusted on the chemical concentration controller. The shredder will continue to run based on the pre-programmed cycle time. The cycle time maybe longer if there are hard substances in the waste. After the cycle time is over the system will stop.

The system will stop during the normal running cycle under the following conditions: water level is low or high; chemical level is low; air pressure is low; any one of the motors fault (overloading or other electrical problems); and E-Stop or Stop push button is pressed. The system will start running the cycle from the beginning when the alarm conditions are cleared and Start button is pressed.

Alarms are indicated by a bell flashing in the upper-right corner of the display when an alarm is activated. To go to the alarms screen, the alarm button on the lower right corner of all the display screens is touched. Alarms are presented in an alarm list with predefined alarm texts. The alarm list contains the latest alarms and is arranged in alarm group order according to definition, so that the latest alarms are shown at the top of the list. The number of times the alarm has been generated (if selected), the status of the alarm, the time it was activated, became inactive or was acknowledged, is shown for every alarm. Touching the acknowledge button accepts an alarm. If the alarm condition is already cleared, then the alarm message line will disappear after acknowledgment. If the alarm condition still exists, the message line will continue to display.

A method of waste treatment according to the present invention is described in FIG. 9. The method includes the steps of pouring waste material into a hopper at 200, providing the waste material from the hopper directly to a grinder at 202, grinding the waste material in the grinder at 204, wetting the ground waste material with a liquid disinfectant at 206, and carrying the wetted waste material on an auger for between two and three minutes at 208.

While the invention herein disclosed has been described by means of specific embodiments and applications thereof, numerous modifications and variations could be made thereto by those skilled in the art without departing from the scope of the invention set forth in the claims.

I claim:

1. Apparatus for hospital waste treatment, comprising:
a hopper for receiving unprocessed waste material;
a grinder for receiving the unprocessed waste material directly from the hopper and grinding the unprocessed waste material, the grinder comprising:
a rotor positioned below the hopper; and
an anvil in cooperation with the rotor, wherein the rotor and anvil are adapted to jointly grind the unprocessed waste material,
a main solution tank for receiving ground material from the grinder;
liquid disinfectant in the main solution tank;
a pump for circulating the liquid disinfectant; and
an auger for carrying wetted material from the main solution tank.

2. The apparatus of claim 1, wherein the grinder includes a ram adapted to push the unprocessed waste material towards the rotor.

3. The apparatus of claim 1, wherein the ram is automatically controlled to improve grinding efficiency.

4. The apparatus of claim 1, wherein:
the rotor is moveably mounted to allow the rotor to move away from the anvil if an object comes between the rotor and anvil thereby urging the rotor away from the anvil; and
the grinder includes a switch which is responsive to movement of the rotor, which switch removes power from the rotor if the movement is sufficiently large.

5. The apparatus of claim 1, wherein a filtering system is in fluid communication with the hopper to draw and filter air inside the hopper.

6. The apparatus of claim 5, wherein the filtering system includes a High Efficiency Particle Arresting (HEPA) filter.

7. The apparatus of claim 1, wherein:
the main solution tank includes a chamber floor, and the liquid disinfectant has a static liquid level of a column extending down to the chamber floor; and
the auger includes an auger floor, and the liquid disinfectant has a dynamic liquid level of a column extending down to the auger floor.

8. The apparatus of claim 7, wherein the auger floor is an auger screen surrounding approximately a lower half of the auger.

9. The apparatus of claim 11, wherein the pump is a chopper pump.

10. The apparatus of claim 9, wherein the pump returns the liquid disinfectant through an auger nozzle directed toward a portion of the auger, wherein the auger nozzle is adapted to spray the liquid disinfectant onto the wetted material carried by the auger.

11. The apparatus of claim 9, wherein the pump draws the liquid disinfectant from the main solution tank and to return the liquid disinfectant to the main solution tank.

12. The apparatus of claim 11, wherein the pump returns the liquid disinfectant through at least two nozzles to the main solution tank.

13. The apparatus of claim 14, wherein the pump returns the liquid disinfectant through three nozzles to the main solution tank, wherein:
a first nozzle is positioned near the chamber floor;
a second nozzle is positioned at an auger end of the main solution tank and in an upper half of the main solution tank; and
a third nozzle is positioned at an end opposite the second nozzle and in the upper half of the main solution tank.

14. The apparatus of claim 1, further including a liquid disinfectant management system comprising:
continuous gas monitoring system for measuring the strength of liquid disinfectant; and
a liquid disinfectant generator controlled by the continuous gas monitoring system.

15. The apparatus of claim 14 wherein the liquid disinfectant generator comprises a chlorine dioxide generator.

16. The apparatus of claim 15 wherein the chlorine dioxide generator converts sodium chlorite, a citric acid solution, and sodium hypochlorite into chlorine dioxide.

17. The apparatus of claim 1, wherein the level of the liquid disinfectant in the main solution tank is measured using a bubble tank assembly.

18. The apparatus of claim 1, wherein the auger includes a de-watering segment opposite the main solution tank.

19. The apparatus of claim 18, wherein the de-watering segment is adjustable to control the amount of de-watering by changing an angular position of the de-watering segment relative to an auger housing.

20. A method for treating hospital waste, the method comprising:
dumping waste material into a hopper;
providing the waste material from the hopper directly to a grinder;
grinding the waste material in the grinder to provide ground waste material;
wetting the ground waste material with a liquid disinfectant to provide wetted waste material;
carrying the wetted waste material on an auger for between two and three minutes.

21. Apparatus for infectious waste treatment, comprising:
a lift for lifting a waste container to a hopper;
a hopper for receiving waste material from the waste container;
a grinder for receiving the waste material directly from the hopper and grinding the waste material, the grinder comprising:
a rotor positioned below the hopper;
an anvil configured to push the waster material into the rotor, and
a sizing screen for releasing sized ground waste material from the grinder;
a main solution tank for receiving and wetting the sized ground waste material which passes through the sizing screen;
a liquid disinfectant in the main solution tank;
an auger for carrying wetted material from the main solution tank; and
a chopper pump for circulating the liquid disinfectant.
